(19) United States
(12) Patent Application Publication
(10) Pub. No.: US 2026/0189718 A1
(43) Pub. Date: Jul. 2, 2026

(54) DECODING METHOD AND DEVICE, ASSOCIATED COMPUTER PROGRAM AND DATA STREAM

(71) Applicant: ORANGE, ISSY LES MOULINEAUX (FR)

(72) Inventors: Félix Henry, SAINT-GREGOIRE (FR); Gordon Clare, PACE (FR); Mohsen Abdoli, THORIGNE FOUILLARD (FR)

(21) Appl. No.: 18/879,321

(22) PCT Filed: Jun. 28, 2023
(86) PCT No.: PCT/EP2023/067734

§ 371 Date: Dec. 27, 2024

(30) Foreign Application Priority Data
Jun. 29, 2022 (FR) FR2206565

(51) Int. Cl. H04N 19/169; H04N 19/157

(52) U.S. Cl. CPC H04N 19/188; H04N 19/157

(57) ABSTRACT

A data stream contains data packets each including at least first data and second data. A method for decoding this data stream includes: identifying, among the data packets, a first data packet the first data of which include information indicating a predetermined type of data packet; processing the second data of the first data packet to obtain an artificial neural network; decoding the second data contained in a second data packet among the data packets, using at least the obtained artificial neural network, so as to produce data representative of audio or video content. An associated decoding device and a computer program are also proposed.

### CROSS REFERENCE TO RELATED APPLICATIONS

This Application is a Section 371 National Stage Application of International Application No. PCT/EP2023/067734, filed Jun. 28, 2023, and published as WO 2024/003191 A1 on Jan. 4, 2024, not in English, which claims priority to and the benefit of French Patent Application No. 2206565, filed Jun. 29, 2022, the contents of which are incorporated herein by reference in their entireties.

### TECHNICAL FIELD OF THE INVENTION

The present invention relates to the technical field of coding audio or video content. It particularly relates to a decoding method and device, as well as to an associated computer program and data stream.

### PRIOR ART

Using artificial neural networks to carry out all or some of the decoding of data representing audio or video content has been proposed.

Document WO 2022/013249 discloses a decoding method in which an indicator is decoded in order to determine whether an artificial neural network is coded in the received data stream or forms part of a predetermined set of artificial neural networks, and in which the artificial neural network is then used in order to decode data representing audio or video content.

### SUMMARY

Within this context, the present invention proposes a method for decoding a data stream comprising data packets each comprising at least first data and second data, characterized in that it comprises the following steps of:
identifying, from among said data packets, a first data packet whose first data includes information indicating a predetermined type of data packet;
processing the second data of the first data packet in order to obtain an artificial neural network;
decoding the second data included in a second data packet from among said data packets, by using at least the obtained artificial neural network and so as to produce data representing audio or video content.

The data that allows the artificial neural network to be obtained and the data that can be decoded using this artificial neural network in order to reproduce the audio or video content is thus conveyed in respective data packets, which facilitates their identification and their use when decoding. The first data packet, which contains the data that allows the artificial neural network to be obtained, in this respect is specifically identified by means of the information indicating the predetermined type of data packet.

The second data of the first data packet includes, for example, descriptive data of the artificial neural network; the processing step then can be a step of decoding the descriptive data in order to obtain parameters of the artificial neural network.

The first data packet can also comprise an identifier of the artificial neural network. This identifier can be an element of a list of distinct identifiers respectively associated with distinct artificial neural networks.

The method can further comprise a step of receiving a third data packet whose first data includes information indicating said predetermined type of packet, and comprising said identifier, and/or a step of reusing said obtained artificial neural network in order to decode second data included in a fourth data packet from among said data packets. Thus, the presence of the identifier in the third data packet indicates that this third data packet also contains data that can be used in order to obtain the artificial neural network defined in the first data packet, and this artificial neural network therefore can be reused without having to again process the data of the third data packet.

The second data packet can also comprise said identifier. In other words, the identifier included in the first data packet and the identifier included in the second data packet are identical. In this case, the identifier then can be used to indicate that it is the artificial neural network defined in the first data packet (which contains this identifier) that must be used in order to decode the data contained in the second data packet (which also contains the identifier in the present case).

Other possibilities nevertheless can be contemplated for indicating the neural network to be used for decoding.

The method can comprise a step of receiving another data packet containing parameters relating to at least one image of said content; in this case, these parameters can include said identifier. The artificial neural network defined in the first data packet will then be used in order to decode the data for obtaining said at least one image of the content.

According to one contemplatable embodiment, the first data packet is, from among the data packets whose first data includes information indicating said predetermined type of packet, the last packet preceding the second data packet in the data stream. In this embodiment, the artificial neural network to be used for decoding the data of the second packet is thus that defined in the last received packet with the predetermined type.

According to one possible embodiment, the second data packet comprises a pointer to the first data packet.

Following the same idea, the method can comprise the following steps of:
reading a flag in the second data packet;
if the flag has a predefined value, reading, in the second data packet, a pointer to the first data packet.

The method can further comprise the following steps of:
receiving another data packet containing parameters relating to at least one image of said content;
reading a flag from among said parameters;
if the flag has a predefined value, reading, from among said parameters, a pointer to the first data packet.

The pointer can designate, for example, a location in a portion of the data stream relating to a sequence of images distinct from the sequence of images at least partly coded by the second data of the second data packet.

Furthermore, the first data packet can comprise information indicating the coding format of the second data of the first data packet.

The first data packet can begin with a predefined marker and the second data packet can, in this case, also begin with said predefined marker. In this case, such a marker identifies the beginning of the data packets.

The first data of a data packet is included, for example, in a header of this data packet, while the second data then can be included in the payload data of this data packet.

The invention also proposes a device for decoding a data stream comprising data packets each comprising at least first data and second data, characterized in that it comprises a processor configured or programmed to:
identify, from among said data packets, a first data packet whose first data includes information indicating a predetermined type of data packet;
process the second data of the first data packet in order to obtain an artificial neural network;
decode the second data included in a second data packet from among said data packets, by using at least the obtained artificial neural network and so as to produce data representing audio or video content.

The invention also proposes a computer program comprising instructions that can be executed by a processor and are designed to implement a method as proposed above, when these instructions are executed by the processor.

Finally, the invention proposes a data stream comprising data packets each comprising at least first data and second data, characterized in that the data packets comprise:
a first data packet whose first data includes information indicating a predetermined type of data packet and whose second data defines an artificial neural network;
a second data packet whose second data can be decoded using at least said artificial neural network so as to produce data representing audio or video content.

As explained above, the first data packet can comprise an identifier; the data stream can comprise another data packet that comprises said identifier, whose first data comprises said information indicating the predetermined type of data packet, and whose second data is identical to the second data of the first data packet.

Of course, the various features, variants and embodiments of the invention can be associated with one another according to various combinations insofar as they are not incompatible or mutually exclusive.

### BRIEF DESCRIPTION OF THE DRAWINGS

Furthermore, various other features of the invention will become apparent from the appended description, which is provided with reference to the drawings, which illustrate non-limiting embodiments of the invention, and in which:

FIG. 1 shows the main elements of a coding device;

FIG. 2 schematically shows a first possible embodiment for a coding module of the coding device of FIG. 1;

FIG. 3 schematically shows a second possible embodiment for the coding module of the coding device of FIG. 1;

FIG. 4 shows a first example of a data stream;

FIG. 5 shows a second example of a data stream;

FIG. 6 shows a third example of a data stream;

FIG. 7 shows a fourth example of a data stream;

FIG. 8 shows a fifth example of a data stream;

FIG. 9 shows a sixth example of a data stream;

FIG. 10 shows the main elements of a decoding device;

FIG. 11 schematically shows a first possible embodiment for a decoding module of the decoding device of FIG. 10;

FIG. 12 schematically shows a second possible embodiment for the decoding module of the decoding device of FIG. 10;

FIG. 13 is a flowchart showing the steps of a decoding method;

FIG. 14 is a flowchart showing the steps of a method that can be contemplated for decoding the data stream of FIG. 5;

FIG. 15 is a flowchart showing the steps of a method that can be contemplated for decoding the data stream of FIG. 6;

FIG. 16 is a flowchart showing the steps of a method that can be contemplated for decoding the data stream of FIG. 7; and

FIG. 17 is a flowchart showing the steps of a method that can be contemplated for decoding the data stream of FIG. 8.

### DETAILED DESCRIPTION OF ILLUSTRATIVE EMBODIMENTS

It should be noted that, in these figures, the structural and/or functional elements common to the various variants can have the same references.

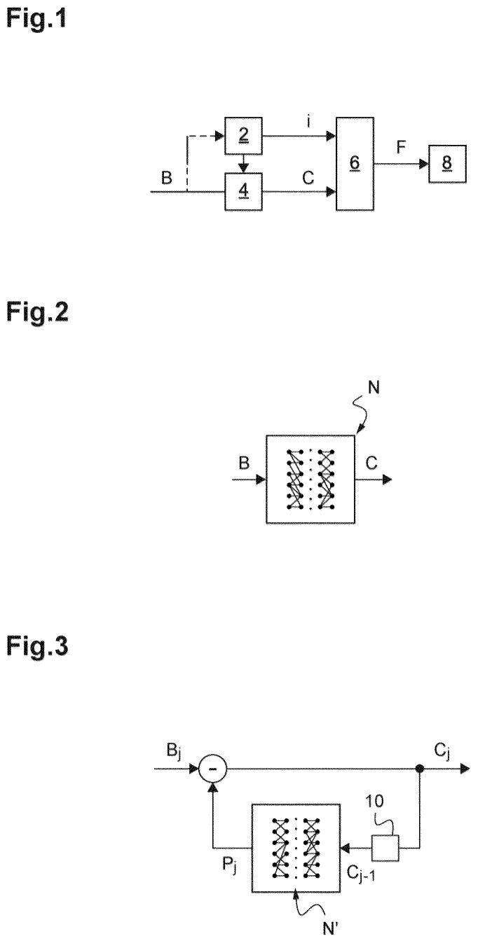

FIG. 1 shows a coding device used within the scope of the invention.

This coding device comprises a management module 2, a coding module 4, a stream formation module 6 and a stream emission module 8.

Each of these modules in practice can be implemented by a programmed processor (for example, by means of instructions stored in a memory associated with the processor) in order to implement the functionalities described below for the relevant module (in this example, since the processor executes some of the aforementioned instructions). Moreover, several modules in practice can be implemented by means of the same processor, for example, due to the execution (by this processor) of several sets of instructions respectively corresponding to the various modules. As a variant, either of the modules can be produced by means of an application specific integrated circuit.

The management module 2 is configured to control the operation of the coding module 4, in particular in order to determine which coding process must be used to code data B representing audio or video content, as will be explained hereafter.

The coding module 4 is configured to receive this data B that represents audio or video content as input and to generate, based on at least a portion of the data B, a coded representation C of this content as output. The size of the coded representation C (in number of bits) is normally less than the size of the corresponding data B (in number of bits).

In the case of video content, the data B includes, for example, values respectively associated with pixels of an image (or of a component of an image) of the video sequence. The data B thus can be luminance values or chrominance values respectively associated with pixels of a component of an image of the relevant video sequence.

In the case of audio content, the data B is data representing a sound signal, for example, in the WAV format (used for audio compact disk storage).

In order to produce the coded representation C based on the data B, the coding module 4 uses at least one artificial neural network N, N°.

According to a first possible embodiment illustrated in FIG. 2, the data B representing audio or video content is applied as input for the artificial neural network N, which then generates a corresponding portion of the coded representation C as output.

The data B applied as input for the artificial neural network N (i.e. applied to an input layer of the artificial neural network N) can represent a block of an image, or a block of a component of an image (for example, a block of a luminance or chrominance component of this image, or a block of a color component of this image), or an image of a video sequence, or a component of an image of a video sequence (for example, a luminance or chrominance component, or a color component), or even a series of images of the video sequence.

In this case, provision can be made, for example, for at least some of the neurons of the input layer to each receive a pixel value of a component of an image, which value is represented by one of the data items B.

According to a second possible embodiment, the coding module 4 processes the data B representing audio or video content in several steps, at least one step of which is carried out by means of an artificial neural network N′.

Thus, as illustrated in FIG. 3, for example, a previously obtained portion Cⱼ₋₁ of the coded representation is applied as input for the artificial neural network N′, which allows predicted data Pⱼ to be generated as output from the artificial neural network N′, which predicted data is subtracted from the current data Bⱼ so as to obtain (as output from the coding module 4) a portion Cⱼ of the coded representation corresponding to the current data Bⱼ.

In FIG. 3, reference 10 represents a delay module in order to illustrate the fact that when processing the current data Bⱼ in order to obtain the portion Cⱼ of the corresponding coded representation, it is a previously obtained portion Cⱼ₋₁ of the coded representation that is applied as input for the artificial neural network N′.

In practice, the portion Cⱼ₋₁ is, for example, previously obtained by processing (by the coding module 4) data Bⱼ₋₁ relating to an image preceding the image represented by the current data Bⱼ.

As a variant, the previously obtained portion used as input for the artificial neural network N′ can be a coded representation portion corresponding to at least one block of the neighboring image of the block whose pixel values are represented by the current data Bⱼ.

During coding, the management module 2 determines which coding process (i.e. which processing carried out by the coding module 4) must be used for coding a data set B representing audio or video content.

The management module 2 thus notably determines which artificial neural network N, N′ must be used within the coding module 4.

The data set B for which the management module 2 determines the process (and notably the artificial neural network N,N′) that is to be used depends on the relevant application. This data set B is, for example, the data set B relating to a given image or the data set B relating to a given sequence of images.

The management module 2 selects, for example, the artificial neural network N,N′ to be used when coding the data set B from among a plurality of predefined artificial neural networks, for example in order to minimize a throughput-distortion criterion (which takes into account the size of the coded representation C and the distortion between the content represented by the data B and the content reconstructed based on the coded representation C).

As a variant, the management module 2 carries out a step of training the artificial neural network N,N′ so as to optimize a given criterion (for example, the aforementioned throughput-distortion criterion) when processing the relevant data set B, and commands the coding module 4 to use the artificial neural network thus trained in order to generate the coded representation C based on the relevant data set B.

The management module 2 can thus produce (notably intended for the stream formation module 6) information i indicating the artificial neural network to be used when decoding the coded representation C. Specifically, the management module 2 can provide such information i for each portion C of the coded representation associated with a data set B as defined above.

In some cases, the artificial neural network to be used for decoding the coded representation C is distinct from the artificial neural network N.

For example, in the case of FIG. 2 (where the artificial neural network N receives the data B as input and as output produces the coded representation C), the artificial neural network to be used for decoding the coded representation C is designed (i.e. in practice trained) so as to minimize the distortion of the data B during their successive passages through the artificial neural network N (in order to produce the coded representation C) and through the artificial neural network to be used for decoding, and/or to minimize the size of the coded representation C (within the meaning of a throughput-distortion criterion).

In the case whereby the management module 2 selects the artificial neural network N from among a plurality of predefined artificial neural networks, the artificial neural network to be used for decoding is the one that in a predefined manner is associated with the selected artificial neural network N. The information i can then designate (for example, within a list of artificial neural networks) this network associated with the selected artificial neural network N.

In the case whereby the management module 2 obtains the artificial neural network N by means of a training step, this training step can allow simultaneous training of the artificial neural network to be used for decoding. The information i can then include descriptive data of the artificial neural network to be used for decoding (this descriptive data can include, for example, weights respectively associated with the neurons of this artificial neural network and determined during the training step).

The stream formation module 6 receives the coded representation C produced by the coding module 4 and the information i supplied by the management module 2, and constructs a data stream F based on these elements. Of course, in practice the stream formation module 6 can receive other data from the coding module 4 and/or from the management module 2.

The stream formation module 6 constructs the data stream F in the form of various data packets intended to be successively sent (for example, transmitted) to the decoding device. These data packets are, for example, respectively network abstraction layer units (NAL units).

The stream formation module 6 constructs the various data packets in accordance with the following description.

In the example described herein, each data packet begins with a predefined marker M (i.e. formed by a predefined sequence, or a predefined pattern, of bits). Any data packet therefore begins in this case with the same marker M, which allows the beginning of a data packet to be identified upon reception of the stream. It is proposed, for example, that the value corresponding to the marker M (i.e. the sequence of bits forming the marker M) is prohibited within the data stream F outside the beginning of the data packets.

As a variant, other means for identifying the data packets in the data stream F could be contemplated, for example a list listing the addresses of the various data packets in the data stream F.

Each data packet in this case further comprises a type identifier that designates the type of relevant data packet from among a predetermined set of possible types.

In the examples described hereafter, at least some of the following types of data packet are used:
a data packet conveying descriptive data of an artificial neural network (to be used for decoding), designated by a first type identifier, designated T1 hereafter;
a data packet conveying coded data representing audio or video content (i.e. in this case, the coded representation C obtained by means of the coding module 4), designated by a second type identifier, designated T2 hereafter;
a data packet conveying parameters relating to audio or video content, or to the decoding process to be used, designated by a third identifier, designated T3 hereafter;
a data packet conveying coded data representing audio or video content, yet with this coded data being obtained by a distinct coding process (and consequently requiring a distinct decoding process) for the aforementioned coded data contained in the T2 type data packets, with this latter type of data packet being designated by a fourth identifier, designated T4 hereafter.

Therefore, data packets exist that contain a coded representation of the content (T2 and T4 type data packets in the example described herein), as well as data packets that contain descriptive data of an artificial neural network (for example, data coded in a given format and representing this artificial neural network), in this case, T1 type data packets, and data packets that contain parameters (in this case, T3 type data packets).

In the embodiment described herein, the data packets containing descriptive data of an artificial neural network (T1 type data packets) comprise:
a marker M;
a type identifier (forming first data for this data packet), in this case assuming the value of T1;
optionally, an identifier NNI associated with the relevant artificial neural network (with the identifier NNI forming part of a predetermined set of identifiers respectively associated with various artificial neural networks);
optionally, a format identifier NNF indicating the format of the descriptive data NNC contained in the data packet;
the descriptive data NNC of the relevant artificial neural network (with this descriptive data NNC forming second data for this data packet).

The T1 type identifier and optionally the identifier NNI and/or the format identifier NNF are included, for example, in a header of the data packet; the descriptive data NNC can then form, for its part, the payload data of the data packet.

The description (or coding) format of the descriptive data NNC (identified as appropriate by the format identifier NNF) can be, for example, the NNR format (MPEG-7, part 17), the NNEF format or the ONNX format. As a variant, the format identifier NNF can designate a format that is permitted by a tool for handling artificial neural networks, or even a format of an artificial neural network identifier from among a predetermined set of artificial neural networks (with the data NNC then comprising such an identifier).

The use of a format identifier NNF in the data packet is not necessary when the format that is used is agreed (predefined) by the coding device and the decoding device (or, in other words, when a single format is used by the decoding device).

When a portion C of the coded representation has been produced by the coding module 4 based on a data set B, the stream formation module 6 receives, as already indicated (from the management module 2), the information i indicating the decoding artificial neural network that is to be used for decoding the portion C. The stream formation module 6 can thus determine, based on this information i, which descriptive data NNC must be placed in a given T1 type data packet, as will become apparent from the examples provided hereafter.

In the embodiments where an identifier NNI is used, then in this case provision is made so that all the data packets containing descriptive data of an artificial neural network (i.e. in this case all the T1 type data packets) comprising a given identifier NNI include identical descriptive data NNC.

In the example described herein, the data packets containing a coded representation of the content (T2 and T4 type data packets) comprise:
a marker M;
a type identifier (forming first data for this data packet), in this case assuming a value of T2 or T4 (with the type being one of the types available for the coded representation of the content);
optionally, an identifier NNI associated with an artificial neural network (in accordance with the same association rule as mentioned above for the T1 type data packets), with this artificial neural network being the one to be used for decoding the coded representation of the content contained in the present data packet;
optionally, a location identifier NNL, such as a file pointer, that indicates the location in the data stream of a data packet containing descriptive data of the artificial neural network to be used for decoding the coded representation of the content contained in the present data packet;
optionally, a remote description indicator DNN indicating whether a data packet containing descriptive data of the artificial neural network to be used is present in the portion of the data stream relating to the sequence of current images or is present in a portion of the data stream relating to an image sequence different from the current image sequence;
the coded representation of the relevant content C (which is a portion of the coded representation generated by the coding module 4 and forms the second data for this data packet).

An image sequence in this case is a set of images that can be obtained by decoding a portion of the coded representation of the content (video in this case) without requiring access to another portion of the coded representation of the content (video in this case).

The T2, T4 type identifier, and optionally the identifier NNI and/or the location identifier NNL and/or the remote description indicator, are included, for example, in a header of the data packet; the coded representation C can then form the payload data of the data packet.

Among the data packets containing a coded representation of the content, some packets can have a particular type for identifying an entry point in the data stream (in this case, the type corresponding to the identifier T4 in the example hereafter). In this case, provision can be made, for example, for only the packets of this type (corresponding to an entry point) to contain an identifier NNI or a location identifier NNL.

According to one contemplatable variant, the identifier NNI and/or the location identifier NNL and/or the remote description indicator DNN could be contained in a data packet conveying parameters relating to an image or to a sequence of images (T3 type data packet in the example described in this case).

Provision also can be made for the stream formation module 6 to construct the data stream F so that any data packet containing a coded representation of the content (T2 or T4 type data packet) and a given identifier NNI is preceded (in the data stream F) by a T1 type data packet also containing this given identifier NNI (and thus descriptive data of the artificial neural network designated by this given identifier NNI).

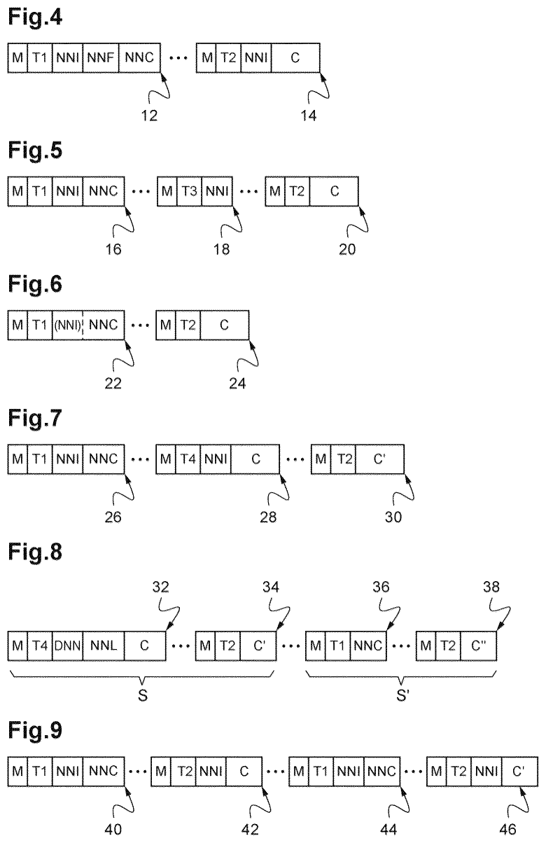

Various examples of contemplatable data streams will now be described with reference to FIGS. 4 to 9. The decoding of these contemplatable data streams will be described subsequently.

A first example of a data stream is shown in FIG. 4.

In this example, the data stream comprises a T1 type data packet 12 and a T2 type data packet 14 (further on in the data stream relative to the packet 12).

The data packet 12 comprises the marker M, an identifier of the type assuming the value of T1, an identifier NNI associated with a given artificial neural network, a format identifier NNF indicating the format of the descriptive data NNC (mentioned hereafter) and this descriptive data NNC of the given artificial neural network.

The data packet 14 comprises the marker M, an identifier of the type assuming the value of T2, the identifier NNI associated with the given artificial neural network (identical to the identifier contained in the data packet 12) and a portion of the coded representation C generated by the coding module 4 and notably decodable using the given artificial neural network.

A second example of a data stream is shown in FIG. 5.

In this example, the data stream comprises a data packet 16, a data packet 18 and a data packet 20, in this order. (Other data packets can be present in the data stream between the data packet 16 and the data packet 18, and/or between the data packet 18 and the data packet 20.)

The data packet 16 comprises the marker M, an identifier of the type assuming the value of T1, an identifier NNI associated with a given artificial neural network, and descriptive data NNC of the given artificial neural network.

The data packet 18 comprises the marker M, an identifier of the type assuming the value of T3 (corresponding, as indicated above, to a data packet containing parameters relating to a given image or to a given sequence of images) and (among these parameters) an identifier NNI associated with the given artificial neural network.

The data packet 20 comprises the marker M, an identifier of the type assuming the value of T2 and a portion of the coded representation C generated by the coding module 4 and notably decodable using the given artificial neural network.

A third example of a data stream is shown in FIG. 6.

In this example, the data stream comprises a data packet 22 and, subsequently in the data stream, a data packet 24.

The data packet 22 comprises the marker M, an identifier of the type assuming the value of T1, optionally an identifier NNI associated with a given artificial neural network, and descriptive data NNC of the given artificial neural network.

The data packet 24 comprises the marker M, an identifier of the type assuming the value of T2 and a portion of the coded representation C generated by the coding module 4 and notably decodable using the given artificial neural network.

A fourth example of a data stream is shown in FIG. 7.

In this example, the data stream comprises a data packet 26, a data packet 28 and a data packet 30, in this order. (Other data packets can be present in the data stream between the data packet 26 and the data packet 28, and/or between the data packet 28 and the data packet 30.)

The data packet 26 comprises the marker M, an identifier of the type assuming the value of T1, an identifier NNI associated with a given artificial neural network and descriptive data NNC of the given artificial neural network.

The data packet 28 comprises the marker M, an identifier of the type assuming the value of T4 (corresponding, as already indicated, to an entry point in the stream), the identifier NNI associated with the given artificial neural network (identical to the identifier contained in the data packet 26) and a portion C of the coded representation generated by the coding module 4 and notably decodable using the given artificial neural network.

The data packet 30 comprises the marker M, an identifier of the type assuming the value of T2 and another portion C′ of the coded representation generated by the coding module 4 and notably decodable using the given artificial neural network.

A fifth example of a data stream is shown in FIG. 8.

In this example, the data stream comprises a data packet 32, a data packet 34, a data packet 36 and a data packet 38, in this order. (Other data packets can be present in the data stream between these various packets.)

The data packet 32 comprises the marker M, an identifier of the type assuming the value of T4 (corresponding, as already indicated, to an entry point in the stream), a remote description indicator DNN, a location identifier NNL and a portion C of the coded representation generated by the coding module 4.

The data packet 34 comprises the marker M, an identifier of the type assuming the value of T2 and another portion C′ of the coded representation generated by the coding module 4.

The data packets 32 and 34 relate to the same sequence of images S, i.e. the portions C, C′ of the coded representation form part of a coded data set allowing decoding of a set of images without having to resort to coded data located outside this coded data set.

The data packet 36 comprises the marker M, an identifier of the type assuming the value of T1 and descriptive data NNC of an artificial neural network.

The data packet 38 comprises the marker M, an identifier of the type assuming the value of T2 and a portion C″ of the coded representation generated by the coding module 4.

The data packets 36 and 38 relate to the same sequence of images S′ that is distinct from the sequence of images S.

The remote description indicator DNN contained in the data packet 32 indicates that the artificial neural network to be used for decoding the portion C (and the portion C′) of the coded representation is not described by descriptive data contained in the sequence of images S, but outside this sequence of images S (in this case, in the sequence of images S′).

The data packet 32 thus comprises the aforementioned location identifier NNL, which in this case is a pointer to the data packet 36 (located in the sequence of images S′).

Such a pointer can be, for example:
a difference in the number of bytes relative to the location of the data packet 32 (with this difference being able to be signed, i.e. have a positive value to indicate a number of bytes in one direction, within the data stream, or a negative value to indicate a number of bytes in the other direction);
a difference in the number of bytes relative to the beginning of the file (or, in other words, of the data stream);
a physical memory storage address (which would have been rewritten by the decoding device when processing the data stream when storing the artificial neural network, then in all the references NNL to this artificial neural network during a preprocessing step).

A sixth example of a data stream is shown in FIG. 9.

In this example, the data stream comprises a data packet 40, a data packet 42, a data packet 44 and a data packet 46, in this order. (Other data packets can be present in the data stream between these various packets.)

The data packet 40 comprises the marker M, an identifier of the type assuming the value of T1, an identifier NNI associated with a given artificial neural network and descriptive data NNC of the given artificial neural network.

The data packet 42 comprises the marker M, an identifier of the type assuming the value of T2, the identifier NNI (identical to that contained in the data packet 40) and a portion C of the coded representation generated by the coding module 4 and notably decodable using the given artificial neural network.

The data packet 44 comprises the marker M, the identifier of the type assuming the value of T1, the identifier NNI associated with the given artificial neural network and the descriptive data NNC of the given artificial neural network (with this data NNC being identical to the data NNC contained in the data packet 40).

The data packet 46 comprises the marker M, the identifier of the type assuming the value of T2, the identifier NNI (identical to that contained in the data packets 40, 42 and 44) and another portion C′ of the coded representation generated by the coding module 4 and notably decodable using the given artificial neural network.

The use of another T1 type data packet 44 containing the descriptive data NNC of the artificial neural network identified by the identifier NNI allows the decoding device to optionally read the data stream in an order other than that shown in FIG. 9, for example to begin reading the data stream at a location other than the data packet 40 (random access). Other data packets identical to the data packets 40, 44 thus can be present, for example, at regular Intervals in the data stream.

In the example described herein, the data stream F constructed by the data formation module 6 is transmitted over a communication channel (optionally after other processing steps, for example an entropy coding step) by the stream emission module 8.

As a variant, the data stream F could be stored (for example, on a storage device, such as a hard disk, of the coding device) for subsequent reading and decoding (with the coding device and the decoding device described hereafter in this case being the same electronic device, for example).

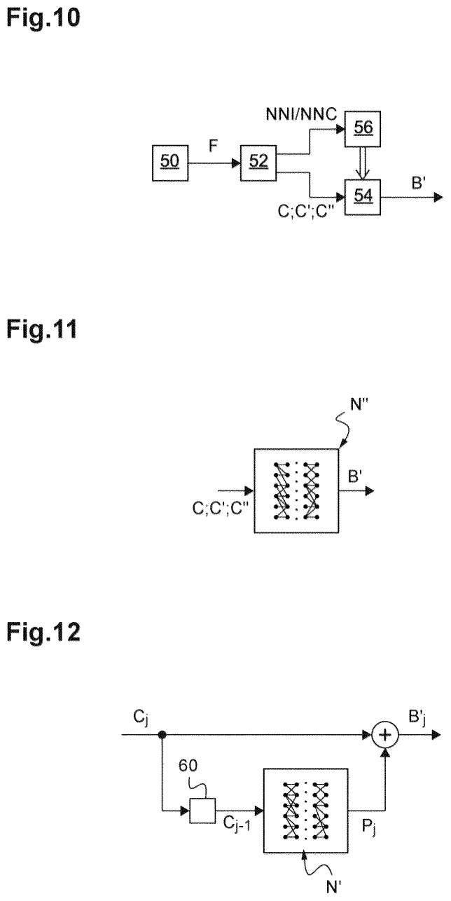

FIG. 10 shows a decoding device according to the invention.

This decoding device comprises a stream reception module 50, a stream analysis module 52, a decoding module 54 and a configuration module 56.

Each of these modules in practice can be implemented by a programmed processor (for example, by means of instructions stored in a memory associated with the processor) in order to implement the functionalities described hereafter for the relevant module (in this example, since the processor executes some of the aforementioned instructions). Moreover, several modules in practice can be implemented by means of the same processor, for example due to the execution (by this processor) of several sets of instructions respectively corresponding to the various modules. As a variant, either of the modules can be implemented by means of an application specific integrated circuit.

The stream reception module 50 receives (for example, via a communication channel) a data stream, such as the data stream F constructed by the stream formation module 6 and emitted by the emission module 8.

According to a previously mentioned variant, this data stream is read on a storage medium, such as a hard disk.

The data stream F (received by the stream reception module 50 or read on a storage medium) is analyzed by the stream analysis module 52, as described hereafter, which allows identification, on the one hand, of the data C, C′, C″ forming a portion of the coded representation of the content and, on the other hand, of an artificial neural network to be used for decoding this data C, C′, C″.

The configuration module 56 is then designed to configure the decoding module 54 so that the decoding module decodes the data C, C′, C″ using the identified artificial neural network, in order to produce data B′ representing audio or video content, as will be explained hereafter within the context of various examples.

According to a first possible embodiment of the decoding module 54 illustrated in FIG. 11, the data C, C′, C″ (coded representation of the content) is applied as input for the identified artificial neural network N″, which then generates the data B′ representing audio or video content as output.

The data B′ produced as output from the artificial neural network N″ corresponds to the data B applied as input for the artificial neural network N and can thus represent a block of an image, or a block of a component of an image (for example, a block of a luminance or chrominance component of this image, or a block of a color component of this image), or an image of a video sequence, or a component of an image of a video sequence (for example, a luminance or chrominance component, or a color component), or even a series of images of the video sequence.

In this case, at least some of the neurons of the output layer of the artificial neural network N″ each produce a pixel value of a component of an image, with the value forming one of the data items B′.

According to a second possible embodiment, the decoding module 54 processes the data C, C′, C″ (designated Cⱼ in FIG. 12) in several steps, at least one step of which is carried out by means of an artificial neural network N′.

Thus, as illustrated in FIG. 12, for example, a portion of the coded representation Cⱼ₋₁ previously received or read in the data stream is applied as input for the artificial neural network N′, which allows predicted data Pⱼ to be generated as output from the artificial neural network N′, which predicted data is combined (for example, by addition) with the current portion Cⱼ of the coded representation so as to obtain (as output from the decoding module 4) a portion B′ⱼ of the data representing audio or video content.

It should be noted that the artificial neural network N′ used for decoding (as shown in FIG. 12) in this case is identical to the artificial neural network N′ used for coding (see FIG. 3 described above).

In FIG. 12, reference 60 represents a delay module for illustrating the fact that when processing the current portion Cⱼ of the coded representation in order to obtain the corresponding portion B′ⱼ of the representative data, it is a previously received (or read) portion Cⱼ₋₁ of the coded representation that is applied as input for the artificial neural network N′.

In practice, as already indicated for the coding, the portion Cⱼ₋₁ relates, for example, to a portion B′ⱼ₋₁ representing an image preceding the image represented by the portion B′ⱼ.

As a variant, the previously received or read portion, used as input for the artificial neural network N′, can be a coded representation portion corresponding to at least one block of the neighboring image of the block whose pixel values are represented by the data B′ⱼ.

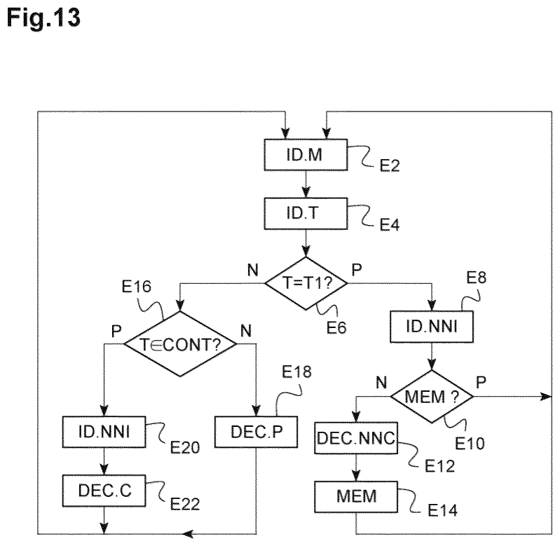

FIG. 13 shows steps of an example of a method for decoding the data stream F.

This decoding method notably can be used for the examples of data streams described above and shown in FIGS. 4 and 9. For this reason, the numerical references mentioned in FIGS. 4 and 9 will be used to illustrate the description of this decoding method.

This method begins with a step E2 in which the analysis module 52 identifies (in the data stream F) the beginning of a data packet 12, 14, 40, 42, 44, 46, in this case by virtue of the marker M through which any data packet begins.

Once the beginning of a data packet is identified, the analysis module 54 can identify its type by reading (and optionally decoding) the T-type identifier (or first data) of this data packet (step E4), for example within the header of this data packet.

The analysis module 54 then determines, in step E6, whether the type indicated by the T-type identifier is a predetermined type (in this case, corresponding to the T1 type). As already indicated, this predetermined type (designated T1 in this case) is associated with the data packets that contain data indicating an artificial neural network.

In the event of a positive determination (arrow P) in step E6, the method continues to step E8. (This is notably the case when processing the data packets 12, 40, 44.)

In the case of a negative determination (arrow N) in step E6, the method continues to step E16. (This is notably the case when processing the data packets 14, 42, 46.)

In step E8, the analysis module 52 reads (and optionally decodes) an identifier NNI in the data stream F, which identifier designates a particular artificial neural network (with the identifier NNI forming part of a predetermined set of identifiers respectively associated with various artificial neural networks).

The analysis module 52 then determines, in step E10 (optionally by cooperating with the configuration module 56), if the artificial neural network designated by the identifier NNI is stored within the decoding device, for example following the prior reception of a data packet that already contained data indicating the artificial neural network (such as the data packet 40).

In the case of a positive determination (arrow P) in step E10 (as is the case when processing the data packet 44 if the data packet 40 has been previously processed), the previously received and stored artificial neural network can be re-used (when subsequently transitioning to step E22 described hereafter), and continuing to process the current data packet therefore is not necessary: the method then loops back to step E2.

However, in the case of a negative determination (arrow N) in step E10 (as is the case when processing the data packet 12 or 40), the method continues to step E12 for reading data NNC in the data stream F and decoding said data (second data of the current data packet) that indicates the artificial neural network associated with the identifier NNI, optionally taking into account the coding format of this indicated data NNC, where appropriate, by means of the format identifier NNF (in the case of the data packet 12), in order to obtain (for example, to construct) the artificial neural network.

As already indicated, notably in the examples of FIGS. 4 and 9, the indicative data NNC is descriptive data of the artificial neural network, which can be decoded (by the stream analysis module 52 or the configuration module 56) so as to obtain parameters of the artificial neural network, with these parameters allowing the configuration module 56 to configure the decoding module 54 so that this decoding module 54 notably implements the artificial neural network (designated by the identifier NNI).

The parameters of the artificial neural network obtained by decoding descriptive data NNC are then stored in a memory of the decoding device (for example, a memory associated with the configuration module 56) in step E14 and the method loops back to step E2 for processing a new data packet of the data stream F.

In step E6, when it has been determined that the type of current data packet does not correspond to the predetermined T1 type, the method continues, as already indicated, to step E16, which will now be described.

In step E16, the stream analysis module 52 determines whether the T-type designated by the type identifier (or first data) of the current data packet 12, 14, 40, 42, 44, 46 forms part of the types associated with the data packets containing a coded representation of the content (which in this case correspond to T2 and T4 types).

In the event of a negative determination (arrow N) in step E16, the method continues to step E18 for decoding the data packet. This is the case, for example, where the data packet contains parameters relating to an image or to a sequence of images (T3 type data packet in the example described in this case) and decoding the current data packet in this case allows parameters to be obtained that relate to an image to be decoded or to the current image sequence (during decoding).

The method then loops back to step E2 for processing another data packet.

In the case of a positive determination (arrow P) in step E16, the method continues with a step E20 of reading (and optionally decoding) an identifier NNI in the data stream F. This identifier NNI designates the artificial neural network to be used for decoding the coded representation C, C′ contained in the current packet 14, 42, 46.

The parameters defining this artificial neural network have been previously obtained by means of the data indicating this artificial neural network contained in a previously received T1 type data packet. In the example described in this case, these parameters have been previously decoded based on the descriptive data NNC contained in a previously received T1 type data packet (data packet 12 in the case of FIG. 4 and, in the case of FIG. 9, data packet 40, or, if data packet 40 has not been read by the decoding device, data packet 44).

The parameters thus obtained (for example, decoded) have also been stored, as already explained, in a memory of the decoding device (in this case a memory associated with the configuration device 56).

The configuration module 56 can then configure the decoding module 54 by means of the parameters of the artificial neural network designated by the identifier NNI read in the data stream in step E20, so that the decoding module 54 can decode a coded representation using this artificial neural network.

The stream analysis module 52 then extracts the coded representation C, C′ (second data) from the current packet and transmits this coded representation C, C′ to the decoding module 54 for decoding this coded representation C, C′ (step E22) using the aforementioned artificial neural network (designated by the identifier NNI read in step E20) in order to obtain, as output from the decoding module 54, data B′ representing audio or video content (with this data being, for example, pixel values of at least one portion of an image or of a component of an image).

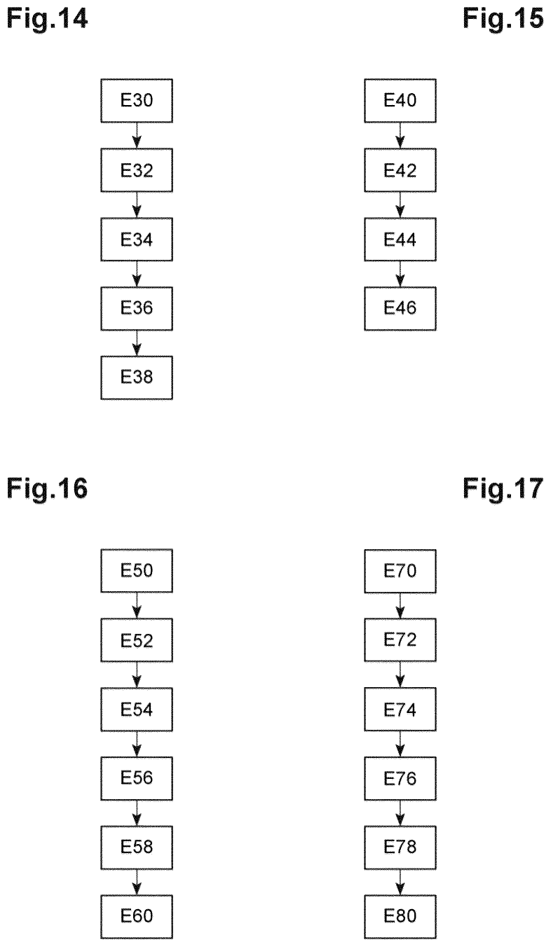

FIG. 14 shows steps of a method that can be contemplated for decoding the data stream of FIG. 5.

This method comprises a step E30 of identifying and analyzing the data packet 16 using the stream analysis module 52.

This step in this case comprises identifying the beginning of the data packet 16 by means of the marker M, detecting the type identifier (first data) corresponding to the predetermined T1 type, and reading (in the data stream) an identifier NNI associated with an artificial neural network and descriptive data NNC (second data) of the artificial neural network corresponding to the identifier NNI.

The method can then comprise a step E32 of decoding data NNC in order to obtain parameters of the artificial neural network, and of storing the obtained parameters in a memory of the decoding device (for example, a memory associated with the configuration module 56).

Subsequently, during step E34, the stream analysis module 52 identifies and analyzes the data packet 18.

Step E34 in this case comprises identifying the beginning of the data packet 18 by means of the marker M, detecting the type identifier, which in this case indicates the T3 type corresponding to the data packets containing parameters relating to at least one image of the current image sequence, and reading (in the data stream) the parameters contained in the data packet 18, with these parameters in this case comprising the identifier NNI.

According to one possible embodiment, the parameters contained in the T3 type data packet 18 can only relate to the image being decoded (i.e. the image whose representative data will be obtained by the next decoding operation by means of the decoding module 54).

The presence of the identifier NNI in the data packet 18 in this case indicates that the artificial neural network associated with the identifier NNI will be used for decoding representative data C associated with the image being decoded (in order to obtain data B′ relating to at least one portion of the image being decoded).

According to another possible embodiment, the parameters contained in the T3 type data packet 18 can relate to all the images of the sequence of images being decoded.

The presence of the identifier NNI in the data packet 18 in this case indicates that the artificial neural network associated with the identifier NNI will be used for decoding representative data C associated with the various images of the sequence of current images (in order to obtain data B′ relating to at least one portion of one of the images of the sequence of current images).

During step E34, according to one possible embodiment, the configuration module 54 can then configure the decoding module 56 so that the decoding module 56 can decode data representing data received in the data stream by using the artificial neural network designated by the identifier NNI. This configuration in practice can be carried out by reading the parameters of the artificial neural network in the aforementioned memory of the coding device (see step E32 hereafter).

Subsequently, in step E36, the stream analysis module 52 identifies and analyzes the data packet 20. In this case, this data packet 20 is considered to be relating to an image to which the parameters contained in the aforementioned data packet 18 apply.

Step E36 in this case comprises identifying the beginning of the data packet 20 by means of the marker M, detecting the type identifier, which in this case indicates the T2 type corresponding to the data packets containing a coded representation of the video, and reading a portion C of the coded representation (second data of the data packet 20).

The method then comprises a step E38 of decoding the portion C of the coded representation via the decoding module 54 using the artificial neural network designated by the identifier NNI.

FIG. 15 shows the steps of a method that can be contemplated for decoding the data stream of FIG. 6.

This method comprises a step E40 of identifying and analyzing the data packet 22 using the stream analysis module 52.

This step in this case comprises identifying the beginning of the data packet 22 by means of the marker M, detecting the type identifier (first data) corresponding to the predetermined T1 type, and reading descriptive data NNC (second data) of an artificial neural network.

Step E40 can also comprise reading and/or decoding an identifier NNI associated with this artificial neural network. As explained in other embodiments, this avoids, in the event of the subsequent detection of a T1 type data packet comprising the same identifier NNI, having to decode the descriptive data NNC of the artificial neural network again.

The method then comprises a step E42 of decoding the data NNC in order to obtain parameters of the artificial neural network, and of storing the obtained parameters in a memory of the decoding device (for example, a memory associated with the configuration module 56). As indicated above, in the embodiments where an identifier NNI is used within the data packet 22 and a previous T1 type data packet conveying this identifier NNI has already been processed, this step can be omitted.

During step E42, the configuration module 54 can configure the decoding module 56 (by means of the obtained parameters, as mentioned above) so that the decoding module 54 can decode the following representative data received in the data stream using the artificial neural network.

The method then comprises a step E44 of identifying and analyzing (by the stream analysis module 52) the data packet 24. In this case, no T1 type data packet is considered to be included between the data packet 22 and the data packet 24.

Step E44 in this case comprises identifying the beginning of the data packet 24 by means of the marker M, detecting the type identifier, which in this case indicates the T2 type corresponding to the data packets containing a coded representation of the video, and reading (in the data stream) a portion C of the coded representation (second data of the data packet 24).

The method then comprises a step E46 of decoding the portion C of the coded representation via the decoding module 54 using the artificial neural network represented by the data NNC contained in the data packet 22.

Thus, in the present embodiment, the artificial neural network used for decoding the coded representation contained in a data packet 24 is defined (by indicative data, in this case, descriptive data NNC, contained therein) in the last T1 type data packet preceding this data packet 24.

FIG. 16 shows steps of a method that can be contemplated for decoding the data stream of FIG. 7.

This method comprises a step E50 of identifying and analyzing the data packet 26 using the stream analysis module 52.

This step in this case comprises identifying the beginning of the data packet 26 by means of the marker M, detecting the type identifier (first data) corresponding to the predetermined T1 type, and reading an identifier NNI in the stream that is associated with an artificial neural network and descriptive data NNC (second data) of the artificial neural network corresponding to the identifier NNI.

The method then comprises a step E52 of decoding the data NNC in order to obtain parameters of the artificial neural network, and of storing the obtained parameters in a memory of the decoding device (for example, a memory associated with the configuration module 56).

Subsequently, during step E54, the stream analysis module 52 identifies and analyzes the data packet 28.

Step E54 in this case comprises identifying the beginning of the data packet 28 by means of the marker M, detecting the type identifier, which in this case indicates the T4 type corresponding to the data packets containing a coded representation of the content and identifying an entry point in the data stream, and reading (in the data stream) the identifier NNI and a first portion C of the coded representation of the content.

The method can then continue with a step E56 of decoding this first portion C of the coded representation of the content, by the decoding module 54 and by means of the artificial neural network associated with this identifier NNI (as contained in the data packet 28). To this end, step E56 in practice can optionally comprise a step of configuring the decoding module 54 using the configuration module 56 and by means of the parameters obtained (and stored) in step E52.

Subsequently, during step E58, the stream analysis module 52 identifies and analyzes the data packet 30.

Step E58 in this case comprises identifying the beginning of the data packet 30 by means of the marker M, detecting the type identifier, which in this case indicates the T2 type corresponding to the data packets containing a coded representation of the content, and reading (in the data stream) a second portion C′ of the coded representation of the content.

Indeed, as already indicated, in this embodiment provision is made so that only the data packets corresponding to a possible entry point in the data stream contain an identifier (in this case NNI) of the neural network to be used for decoding coded representations of the content.

The method can then continue with a step E60 of decoding this second portion C′ of the coded representation of the content using the decoding module 54 and by means of the associated artificial neural network of the identifier NNI contained in the data packet 28 designated as a possible entry point by the T4 type identifier contained in this data packet 28.

FIG. 17 shows the steps of a method that can be contemplated for decoding the data stream of FIG. 8.

This method comprises a step E70 of identifying and analyzing the data packet 32 using the stream analysis module 52.

Step E70 in this case comprises identifying the beginning of the data packet 32 by means of the marker M, detecting the type identifier, which in this case indicates the T4 type corresponding to the data packets containing a coded representation of the content and identifying an entry point in the data stream, and reading (in the data stream) the remote description indicator DNN, the location identifier NNL and a first portion C of the coded representation of the content.

Indeed, in this case the remote description indicator DNN is considered to assume a value (for example, the value of 1) indicating that the artificial neural network to be used to decode the first portion C is described outside the current sequence S. As a result, the stream analysis module 52 reads the location identifier NNL located after (in this case immediately after) the remote description indicator DNN in the data stream.

The stream analysis module 52 then browses the data stream according to the indications provided by the location identifier NNL (for example, by browsing the difference in bytes indicated by the location identifier NNL, or by jumping to the physical memory storage address indicated by the location identifier NNL) until the data packet 36 (step E72) is read and analyzed.

This step E72 in this case comprises identifying the beginning of the data packet 36 by means of the marker M, detecting the type identifier (first data) corresponding to the predetermined T1 type, and reading descriptive data NNC (second data) of an artificial neural network in the data stream.

The method then comprises a step E74 of decoding the data NNC in order to obtain parameters of the artificial neural network, and of storing the obtained parameters in a memory of the decoding device (for example, a memory associated with the configuration module 56).

The method can then continue with a step E76 of decoding the first portion C of the coded representation of the content using the decoding module 54 and by means of the aforementioned artificial neural network (decoded from the descriptive data NNC contained in the data packet 36). To this end, step E76 in practice can optionally comprise a step of configuring the decoding module 54 using the configuration module 56 and by means of the parameters obtained (and stored) in step E74.

Subsequently, during step E78, the stream analysis module 52 identifies and analyzes the data packet 34.

Step E78 in this case comprises identifying the beginning of the data packet 34 by means of the marker M, detecting the type identifier, which in this case indicates the T2 type corresponding to data packets containing a coded representation of the content, and reading (in the data stream) a second portion C′ of the coded representation of the content.

Indeed, as already indicated, in this embodiment provision is made so that only the data packets corresponding to a possible entry point in the data stream contain an identifier (in this case NNI) of the neural network to be used for decoding encoded representations of the content.

The method can then continue with a step E80 of decoding this second portion C′ of the coded representation of the content, using the decoding module 54 and by means of the artificial neural network obtained as described above in steps E74 and E76 by means of the location identifier NNL contained in the T4 type data packet 32 preceding the present data packet 34.

The optional subsequent processing of the data packet 38 (when decoding the sequence S′) is not described herein.

Although the present disclosure has been described with reference to one or more examples, workers skilled in the art will recognize that changes may be made in form and detail without departing from the scope of the disclosure and/or the appended claims.

1. A decoding method for decoding a data stream comprising data packets each comprising at least first data and second data, wherein the method is implemented by a decoding device and comprises:
identifying, from among said data packets, a first data packet whose first data includes information indicating a predetermined type of data packet;
processing the second data of the first data packet in order to obtain an artificial neural network; and
decoding the second data included in a second data packet from among said data packets, by using at least the obtained artificial neural network and so as to produce data representing audio or video content.

2. The decoding method as claimed in claim 1, wherein the second data of the first data packet includes descriptive data of the artificial neural network, and wherein the processing comprises decoding the descriptive data in order to obtain parameters of the artificial neural network.

3. The decoding method as claimed in claim 1, wherein the first data packet comprises an identifier of the artificial neural network.

4. The decoding method as claimed in claim 3, wherein the identifier is an element of a list of distinct identifiers respectively associated with distinct artificial neural networks.

5. The decoding method as claimed in claim 4, comprising receiving a third data packet whose first data includes information indicating said predetermined type of packet, and comprising said identifier, and reusing said obtained artificial neural network in order to decode second data included in a fourth data packet from among said data packets.

6. The decoding method as claimed in claim 3, wherein the second data packet comprises said identifier.

7. The decoding method as claimed in claim 3, comprising receiving another data packet containing parameters relating to at least one image of said content, wherein said parameters include said identifier.

8. The decoding method as claimed in claim 1, wherein the first data packet is, from among the data packets whose first data includes information indicating said predetermined type of packet, a last packet preceding the second data packet in the data stream.

9. The decoding method as claimed in claim 1, wherein the second data packet comprises a pointer to the first data packet.

10. The decoding method as claimed in claim 1, comprising:
reading a flag in the second data packet; and
in response to the flag having a predefined value, reading, in the second data packet, a pointer to the first data packet.

11. The decoding method as claimed in claim 1, comprising:
receiving another data packet containing parameters relating to at least one image of said content;
reading a flag from among said parameters; and
in response to the flag having a predefined value, reading, from among said parameters, a pointer to the first data packet.

12. The decoding method as claimed in claim 9, wherein the pointer designates a location in a portion of the data stream relating to a sequence of images distinct from a sequence of images at least partly coded by the second data of the second data packet.

13. The decoding method as claimed in claim 1, wherein the first data packet comprises information indicating a coding format of the second data of the first data packet.

14. A device for decoding a data stream comprising data packets each comprising at least first data and second data, wherein the device comprises:
at least one processor configured or programmed to:
identify, from among said data packets, a first data packet whose first data includes information indicating a predetermined type of data packet;
process the second data of the first data packet in order to obtain an artificial neural network; and
decode the second data included in a second data packet from among said data packets, by using at least the obtained artificial neural network and so as to produce data representing audio or video content.

15. A non-transitory computer readable medium comprising a computer program stored thereon comprising instructions that, when executed by a processor, configure the processor to implement a method for decoding a data stream comprising data packets each comprising at least first data and second data, wherein the method comprises:
identifying, from among said data packets, a first data packet whose first data includes information indicating a predetermined type of data packet;
processing the second data of the first data packet in order to obtain an artificial neural network; and
decoding the second data included in a second data packet from among said data packets, by using at least the obtained artificial neural network and so as to produce data representing audio or video content.

16. (canceled)

17. (canceled)
